(19) United States
(12) Patent Application Publication
(10) Pub. No.: US 2010/0284191 A1
(43) Pub. Date: Nov. 11, 2010

(54) LIGHTING BODY

(75) Inventor: Daniel Duchowicz, Gottlieben (CH)

Correspondence Address: ROTHWELL, FIGG, ERNST & MANBECK, P.C., 1425 K STREET, N.W., SUITE 800, WASHINGTON, DC, 20005, US

(73) Assignee: IMC EST., Balzers (LI)

(21) Appl. No.: 12/678,600

(22) PCT Filed: Sep. 17, 2008
(86) PCT No.: PCT/EP2008/007770

§ 371 Date: Jul. 19, 2010

Related U.S. Application Data
(60) Provisional application No. 60/974,622, filed on Sep. 24, 2007.

(30) Foreign Application Priority Data
Sep. 17, 2007 (EP) 07018186.2

(51) Int. Cl. F21V 17/02; F21V 5/02; F21V 5/04; F21V 7/00

(52) U.S. Cl. 362/282; 362/339; 362/340; 362/311.01; 362/296.01

(57) ABSTRACT

The invention relates to a special headlight lens and a special lamp provided with said headlight lens having low energy consumption, low diffused light loss and a rectangular light field. The invention further relates to the range of possible applications for the professional lighting of large areas or as component of beamers, projectors, and medical luminaires.

### FIELD OF THE INVENTION

The present invention relates to a novel headlight lens and an energy-saving luminaire equipped therewith and having a defined rectangular light field, and to the use thereof for predominantly professional, in particular large-area, illumination purposes.

### PRIOR ART

The prior art discloses numerous lighting systems for large-area illumination purposes. Examples are the illumination of ski slopes, football stadia, roads and tunnels, advertising boards, exterior facades of buildings, etc.

Common to almost all these lighting systems is their relatively large diffused light fraction of up to 80% of the light emerging from the luminaire, i.e. a major part of the energy which is intended for illuminating the target object does not reach the target object at all but brightens the environment or, worse still, has an adverse financial as well as an ecological effect through energy wastage and light pollution. A further disadvantage is that, on illumination of long target objects, such as, roads or tunnels, generally dark, shadowy regions result between the individual light fields of the luminaires arranged in series, which is found to be very unpleasant and disturbing, particularly when travelling through tunnels.

### BRIEF DESCRIPTION OF THE INVENTION

In order to remedy the circumstance, the present invention now provides a lighting system which drastically reduces the diffused light fraction owing to an ingenious optical lens system and a suitable reflector.

A special lens of this type is protected in Claim 1, and a luminaire equipped therewith is protected in Claim 5.

Modifications of the lens and of the luminaire are defined in the dependent claims.

The invention therefore relates, in a first embodiment, to a headlight lens in the form of a circular disc which is suitable for producing a rectangular light field on a planar surface. It has a first side which is to face a lighting means, referred to below as the light entry side, having an associated surface structure, and a second side located opposite the light entry side, referred to below as light exit side, likewise having an associated surface structure. In addition, it has the following features:
a) on the light entry side, a central, circular section having a surface structure comprising a multiplicity of elongated, prisms arranged parallel to one another and spanning the respective total available circular area and having an approximately triangular cross-section and, located in between, approximately U-shaped trough-like valleys;
b) on the light entry side, immediately adjacent to the circular section and completely surrounding said section, an annular section having a surface structure comprising a multiplicity of elongated venetian blind-like bulges which are arranged parallel to one another and are convex transversely to their longitudinal axis and which span the respective total available annular area;
c) on the light exit side, a central, circular section having two semicircular halves which are of equal size, have a wedge-shaped radial cross-section and, along an imaginary section line, are either directly adjacent to one another or are separated from one another by a strip-like lens section, have their thinnest point in the region of the imaginary section line and become thicker from there in a centrifugal direction, so that their planar surfaces represent skew planes which rise in the direction towards the edge of the lens;
d) on the light exit side, immediately adjacent to the circular section and completely surrounding said section, an annular section having a surface structure comprising a multiplicity of elongated prisms arranged parallel to one another, spanning the respective total available annular area and having a triangular cross-section and, located in between, V-shaped valleys; and
e) on the light entry side and light exit side, immediately adjacent to the annular sections and completely surrounding said sections, a peripheral, annular edge zone without surface structure;
   on the light entry side, the elongated, venetian blind-like bulges of the annular section being arranged rotated through an angle of 90° relative to the elongated prisms of the circular section on the same side thereof, moreover, on the light exit side, the imaginary section line and the strip-like lens section between the semicircular sectional halves running in the same direction as the elongated prisms of the annular section on this side, and the elongated prisms on the light entry side and those on the light exit side being arranged so as to run in the same direction.

The elongated prisms of the lens according to the invention are integrated in the surface structure and oriented so that they have a single free edge which points away from the lens surface. For the purposes of the present invention, prisms having a triangular or approximately triangular cross-section are to be understood as meaning those whose free edge pointing away from the lens surface is rounded.

In a further embodiment, the invention relates to such a lens in which the peripheral, annular edge zone has a thickness which is sufficient for projecting beyond all surface structures arranged within the edge zone. Consequently, this thickened edge zone can act as a fixing base for a planar protective cover for the lens, which can prevent soiling of the lens or damage to the lens.

In a typical embodiment, the lens according to the invention has 23 elongated prisms and 40 elongated, convex bulges on the light entry side and 38 elongated prisms on the light exit side. Depending on the desired light field geometry, the number of prisms and/or bulges may vary, as may the slope of the prisms and/or the thickness and width of the convex bulges.

The lens according to the invention typically consists of an impact-resistant and scratch-resistant transparent, colourless plastic, in particular of polycarbonate (PC), but can in principle also consist of glass, especially toughened glass.

In a further embodiment, the invention also relates to a luminaire which is equipped with such a lens, for example a luminaire comprising a lighting means, a housing, a reflector and the lens, the reflector being formed rotationally symmetrically about its longitudinal axis and being composed in the axial direction of three sections directly following one another and of different geometry: the reflector section closest to the lighting means has the form of a paraboloid of rotation with an opening at the peak, while the two sections adjacent thereto each have the form of a truncated cone widening conically towards the lens, the outer section having a greater slope than the preceding, middle section and optionally also possibly being in the form of a cylinder.

The opening at the peak of the first reflector section is dimensioned with respect to its diameter so that it permits the passage of a lighting means, in particular of a discharge lamp, a lamp holder or cables for power supply.

Typically, the reflector is made of light metal, in particular of aluminium, and has a highly polished or reflective inner surface in the first two sections and a roughened inner surface in the outer, third, conical or cylindrical section, the result of which is that this part of the reflector makes no optical contribution to the diffraction and/or refraction of the light beams and moreover should make no such contribution at all. It serves in principle rather as a type of buffer zone within which the lens position can vary slightly along the longitudinal axis of the reflector (focal line).

The lens can be detachably fastened to the lamp housing and optionally rotatably mounted in the lamp housing.

The invention also relates to the use of a lens according to any of Claims 1 to 4 for producing a rectangular light field.

The invention furthermore relates to the use of such a luminaire for illuminating large areas, such as public squares, recreation parks, sports fields, football stadia, ski slopes, sport and industrial halls, car parks, multi-storey car parks, traffic areas of all kinds, tunnels, building facades, airports, seaports, military areas, advertising boards or exterior facades of buildings.

The luminaire according to the invention can, however, also be used as a component of optical presentation systems, such as projectors and beamers, as a photographic light or as a special luminaire in medical devices, in particular as an operating theatre luminaire or dental luminaire, or in museums for illuminating pictures and other exhibits.

### DESCRIPTION OF FIGURES

FIG. 1 shows the light exit side of the lens according to the invention from FIG. 2, in oblique view.

FIG. 2 shows the complete lens in a horizontal frontal view.

FIG. 3 shows the light entry side of the lens from FIG. 2, in oblique view.

FIG. 4A,4B show a schematic cross-sectional view of the luminaire according to the invention with reflector and housing;

FIG. 4A=details; FIG. 4B=dimensioning

FIG. 5 shows a schematic diagram of the light cone and hence of the illuminatable area of a conventional street lamp with a 120 degree optical system compared with a luminaire according to the invention having a 160 degree optical system, when mounted at a height of 9 m above the ground.

FIG. 6 shows the light exit side of a variant of the lens according to the invention, in an oblique view.

FIGS. 7A, 7B show cross-sections of the lens variant along the section line A-A, FIG. 7B showing the dimensioning.

FIG. 8 shows the light entry side of the lens variant from FIG. 7A in an oblique view.

FIGS. 9A, 9B show cross-sections of the lens variant from FIG. 7A in oblique view: FIG. 9A as a solid diagram, FIG. 9B as a wireframe graphic.

FIG. 10 shows the horizontal frontal view of the lens from FIG. 2, in slight magnification and with dimensioning.

### DETAILED DESCRIPTION OF THE INVENTION

A primary purpose of the luminaire according to the invention is to diffract and to focus the light beams emitted by a light source so that a rectangular light field can be produced by a round headlight cone on a planar surface located opposite.

Its most substantial advantage is that the diffused light fraction and hence the undesired light loss is typically less than 10%, i.e. that at least 90% of the remaining light emerging from the lens are radiated in the form of a rectangular light field onto the target object to be illuminated.

The invention is furthermore distinguished in that, starting from the bright centre, the light field produced loses light intensity only slightly in the direction towards the edge and has a significantly lower light intensity deviating therefrom only in the edge region itself. This makes it possible to achieve a continuous light strip of approximately constant brightness if the luminaires according to the invention are positioned adjacent to one another in such a way that the edge regions of the radiated light fields overlap one another. In comparison with conventional luminaires, the number of luminaires can also be reduced in some cases, with the result that in particular maintenance costs, electricity costs, infrastructure costs and installation costs decrease substantially.

As a result of the precise light distribution, there is almost no light wastage and only very little lateral dazzling. This helps to increase the efficiency of illumination and to reduce the wattage so that a very bright light field can be produced even with relatively weak lighting means.

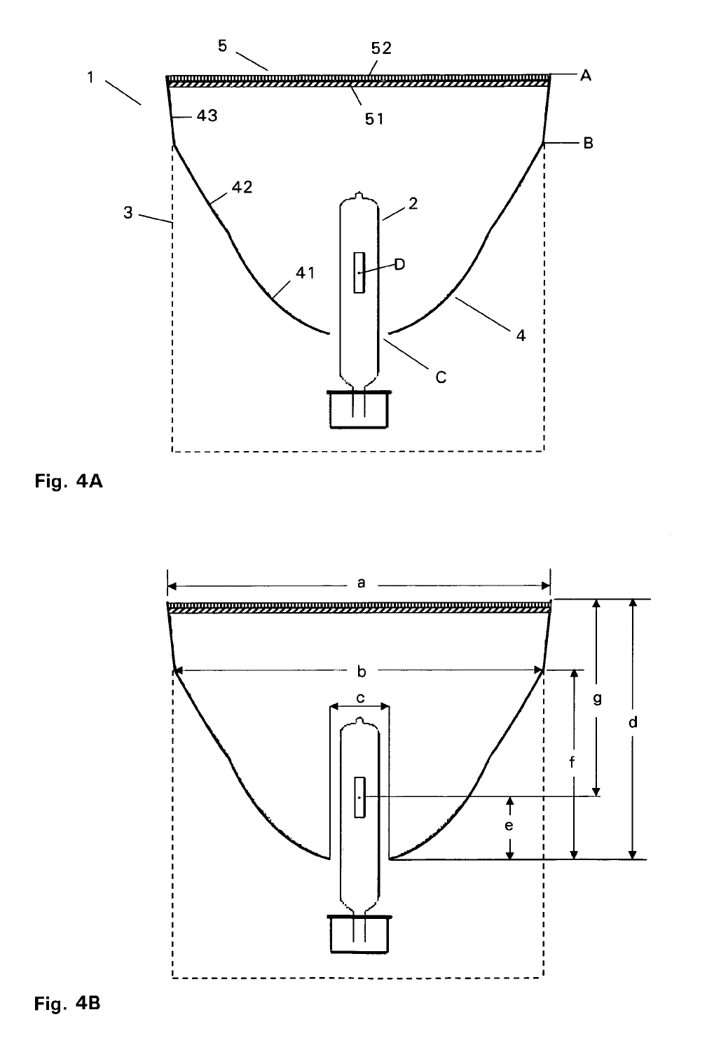

These effects and advantages are achieved by the luminaire 1 shown schematically in FIG. 4 and comprising a light source 2, a lamp housing 3, a reflector 4 and a round lens system 5.

The luminous efficiency is decisively influenced by the geometry and surface character of the mirrored reflector, while primarily the geometry of the lens is decisive with regard to the lighting effect. For this reason, the lens 5, 5a according to the invention, which has a circular shape, possesses a different surface geometry on the light entry side 51, 51a from that on the light exit side 52.

Here, light entry side is understood as meaning that side of the lens which faces the light source or the lighting means when the lens has been installed in the luminaire according to the invention. Consequently, light exit side is to be understood as meaning the opposite side of the lens, i.e. that side which faces the object to be illuminated when the lens is installed in the luminaire according to the invention.

The lens 5, 5a contains, at the edge, an annular edge zone 53 without a special surface structure. An annular section 511 which has a surface structure comprising parallel rows of elongated, bead-like elevations or bulges is adjacent to this edge zone in the direction towards to the centre of the lens, on the light entry side 51, 51a, the bulges being convex and running transversely to the longitudinal axis of the respective elongated elevations. The elongated elevations or bulges having such a convex curvature resemble, in plan view, the shape of a venetian blind with convex plastic lamellae in the maximum closed or shade position.

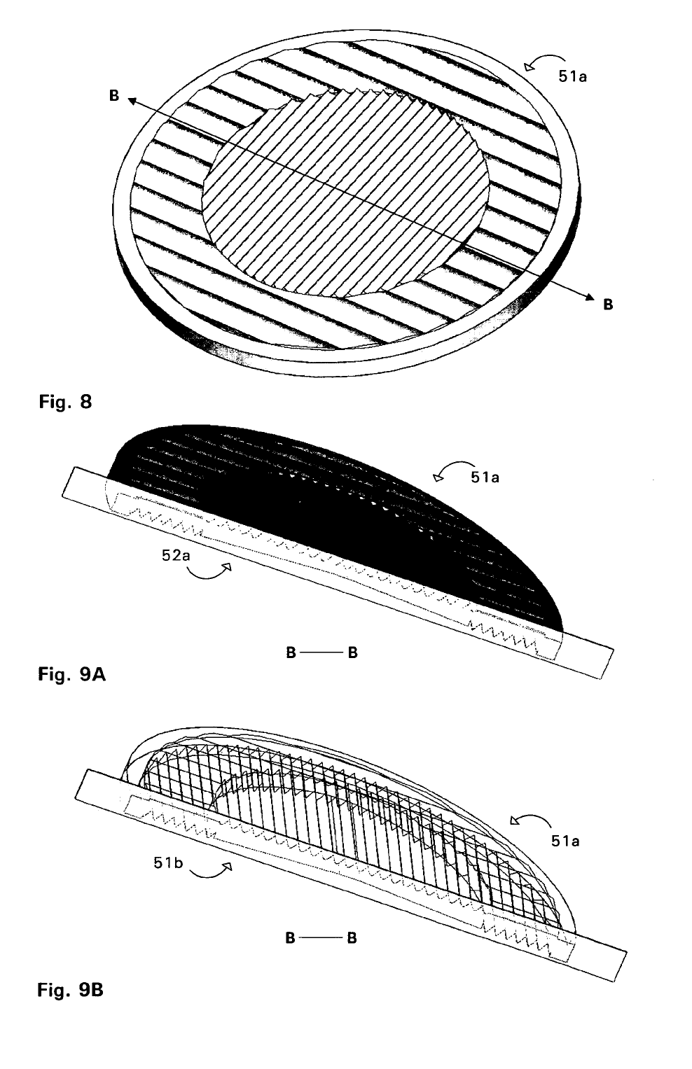

The central section 512 which remains within this circular ring and is directly adjacent thereto is circular and has a surface structure comprising parallel rows of elongated prisms having an approximately triangular cross-section, which taper along their longitudinal axis in an outward direction, i.e. in the direction pointing away from the lens surface. Their lateral flanks are not strictly planar but slightly concave (cf. cross-sections in FIGS. 9a and 9b) so that in each case two such elongated prisms between them form a U-shaped trough valley.

On the light exit side 52, 52a of the lens, an annular section 521 having a surface structure comprising parallel rows of likewise elongated, tapering prisms having a triangular cross-section is adjacent to the outer edge zone 53 and is followed by a central, circular section having a smooth surface. It consists of two halves of equal size which pass seamlessly one into the other at an imaginary section line 524 running centrally to the circular area and have their smallest thickness there. In another embodiment, the section line is present in broadened form as a strip-like section which separates the two semicircular sections from one another and at the same time connects them to one another. The two circular halves are arranged so that the imaginary section line or the strip-like lens section is parallel to the prism rows on the same side. The planar surfaces of these two semicircular lens sections 522, 523, 522a, 523a lie not in the central lens plane or parallel to it but ascend in the form of skew planes in the centrifugal direction, i.e. in a direction perpendicular to the imaginary section line, since the two sections 522, 523, 522a, 523a each become thicker towards the edge and assume a wedge-shaped form. The planar, non-curved surfaces of the two semicircular lens sections 522, 523 together form—with respect to the lens plane—an obtuse angle opening outwards, so that the circular lens section, when viewed from the side, appears to have a bend. In the case of the embodiment comprising the strip-like lens section located in between, two bends are evident in this mode of viewing.

On the light entry side, the parallel rows of the convex bulges of the section 511 are arranged rotated by an angle of 90 degrees to the parallel rows of the elongated prisms of the section 512 on the same lens side.

In contrast, the prism rows have the same orientation on the light entry side and light exit side (cf. cross-sections in FIGS. 9a and 9b).

In a preferred embodiment of the luminaire according to the invention, the reflector 4 is formed rotationally symmetrically about its longitudinal axis and, in the axial direction, is composed of three sections 41, 42, 43 of different geometries. As a result, a major part of the light radiated by the lighting means within the reflector in lateral directions is guided to the lens.

In particular, the reflector is configured so that the section 41 closest to the light source has the form of a paraboloid of rotation and has an opening at the peak, while the adjacent, middle section 42 and also the following, outer section 43 have the form of a truncated cone widening conically outwards, i.e. in the direction towards the lens, where the outer section 43 has a steeper conical form than the middle section. Optionally, this outer section may also assume the form of a cylinder.

The opening at the peak of the reflector is typically dimensioned so that the passage of a light source, for example of a high-pressure discharge lamp, a lamp holder or cables for power supply is possible.

The reflector 4 is moreover typically made of light metal, in particular of aluminium, and has a highly polished or reflective inner surface in the inner sections 41 and 42 and roughened inner surface in the outer section 43. The roughened surface of the outer section prevents this reflector section from making an optical contribution to the reflection and/or diffraction of the light emitted by the lighting means.

The middle section on the other hand is very different: it is likewise conical but with a shallower conical form and has the function of returning to the lens the light deflected back by the lens via diffraction and total reflection to the prism rows in the reflector which act as diffusers, so that the light focused by the paraboloid part of the reflector at the focal point in the lens plane is distributed over as large a focal area as possible before it leaves the lens. The focal area lies exactly in the lens plane. As a result of this lens geometry in interaction with the reflector specially tailored thereto, it is moreover ensured that as much light as possible leaves the lens via targeted internal total reflection in the lens optical system and not only by material-dependent diffraction. It is thus possible uniformly to distribute the light intensity of the radiated light over a larger area of the light field.

In a further, advantageous embodiment of the luminaire according to the invention, the lens 5 is displaceably, i.e. rotatably, mounted on the lamp housing 3 so that the light field, too, can be rotated by simple rotation of the lens in the lens plane. Consequently, a fixed luminaire can be easily and quickly adapted to changed illumination requirements without resulting in a loss of light owing to this. The reason for this lies in the rotationally symmetrical reflector.

The lens itself is preferably made of a suitable impact-resistant and scratch-resistant, transparent, colourless plastic, such as, for example, polycarbonate, or optionally of toughened glass, so that it requires no special protection per se from mechanical damage. Nevertheless, it may be advantageous for some intended uses also to place a planar protective glass, in front of the lens, for example in order to prevent soiling of the lens optical system or damage to said system and to permit easier cleaning of the luminaire. This is particularly readily possible especially in the embodiment shown in FIGS. 6 to 8 and having a thickened edge zone 53.

If a luminaire according to the invention is viewed from the front when it is switched on, the prism arrangement prevents the light source from being visible, resulting in a considerably reduced dazzle effect as a further advantage.

With a single luminaire of this type, for example, a rectangular field of 35×10 m can be illuminated almost uniformly, only a maximum of 30-60 watt being required for this purpose instead of 300 watt as in the case of conventional luminaires.

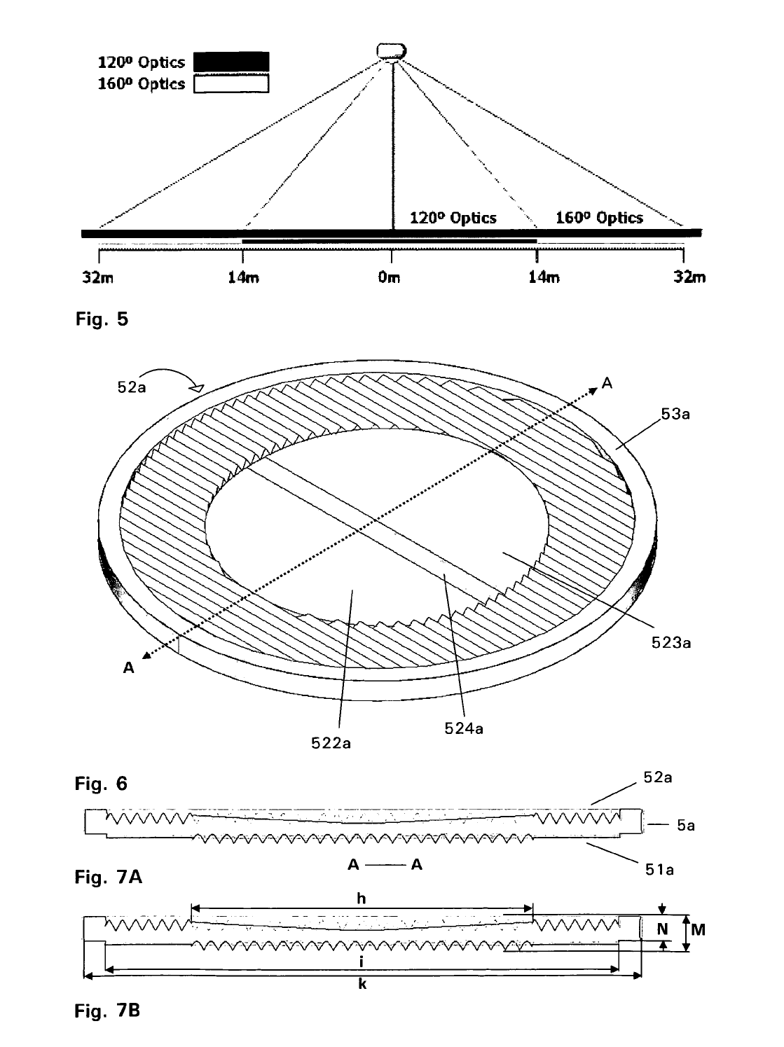

The difference between the area illuminated by a standard street light with a 120 degree optical system and the area illuminated by a luminaire according to the invention having a 160 degree optical system when the luminaire is mounted at a height of 9 m above the ground (e.g. a roadway) is illustrated in FIG. 5. However, the values given there should be regarded as approximate values and may differ therefrom by about 10%. In practice, however, light angles of 160° can no longer be produced in the same quality and at the same economy as light angles of 130 degrees or less, even with the optical system according to the invention. The light angles which can preferably be produced with the optical system according to the invention are in the range from 30 to 130 degrees, in particular from 60 to 120 degrees.

The entire lens optical system, including the reflector, can be installed in different housing types, for example in the lamp housing of flood lights, street lights and special lights of very different types.

The luminaire according to the invention is suitable in particular for illuminating large areas, such as, for example, public squares, recreation parks, sports fields, football stadia, ski slopes, sport and industrial halls, car parks, multi-storey car parks, traffic areas of all kinds, tunnels, airports, seaports, military areas, advertising boards, exterior facades of buildings, etc. However, it can also be part of optical presentation systems, such as projectors and beamers. Likewise, it can be used as a photographic light for professional photographers or as a special luminaire in medical facilities, for example as an operating theatre luminaire or dental luminaire, or in museums for uniform illumination of pictures and other exhibits.

Below, the invention is further explained with reference to examples. The explanations serve exclusively for a better understanding of the invention and permit no inferences at all concerning a limitation of the invention to the examples listed.

### Example 1

An aim of the invention is to illuminate very large areas with a very low power consumption. Savings of up to 80% compared with conventional luminaires comprising metal halide, mercury, high-pressure sodium or low-pressure sodium lamps are possible with the luminaire according to the invention.

The lens preferably consists of PC (polycarbonate) but may also consist of glass or other transparent, light-permeable materials, in which case, however, the lens geometry should be adapted to the changed refractive indices compared with PC.

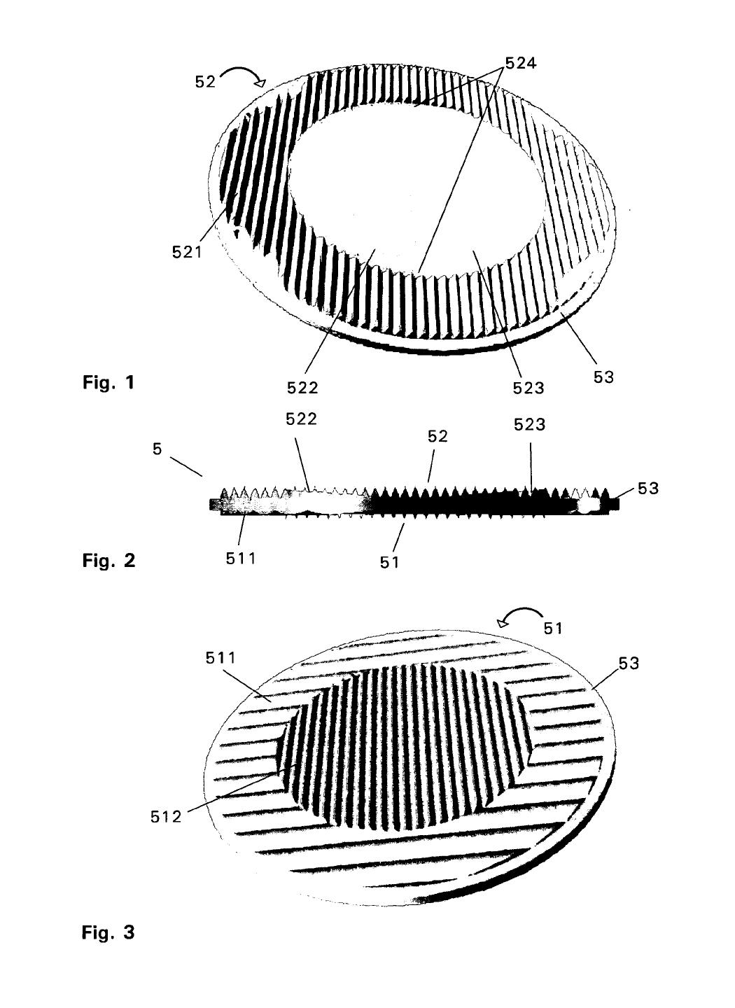

The lens optical system, by way of example for a typical luminaire according to the invention having a diffusion angle of 60°×130° (i.e. a rectangular “light cone”), is shown in FIGS. 1-3 and FIG. 10.

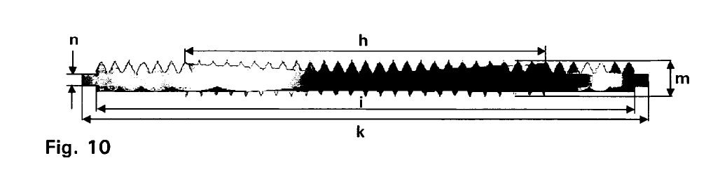

The lens 5, 5a has a total diameter of 190 mm (distance k in FIG. 7B and FIG. 10), the lens part having a structured surface occupying only 180 mm (FIG. 7B, FIG. 10, distance i). The remainder corresponds to the edge zone 53 in FIG. 1, FIG. 2 and FIG. 3, which consequently has a width of 5 mm. The inner lens array, consisting of the section 512 on the light entry side and the sectional parts 522 and 523 or 522a and 523a on the light exit side, has a diameter of 120 mm (distance h) but may vary slightly according to the desired diffusion angle. Accordingly, the outer annular lens array, consisting of the sections 511 (light entry side) and 521 (light exit side), has a width of 30 mm but may also vary according to the variation of the inner lens array. The maximum thickness of the lens, measured from prism vertex or prism edge on the light entry side to prism vertex or prism edge on the light exit side, is 10.7 mm (FIG. 10, distance m) to 12 mm (FIG. 7B, distance M) and the thickness of the annular region 53 at the edge is 3.8 mm (FIG. 10, distance n) to 9.5 mm (FIG. 7B, distance N). In the embodiment shown in the figures (e.g. FIG. 3), the inner lens array 512 has exactly 23 parallel prism rows on the light entry side while the outer annular lens array 521 on the light exit side has exactly 38 parallel prism rows. In this embodiment of the lens, the annular section 511 on the light entry side additionally has a surface structure comprising exactly 14 parallel rows of elongated, venetian blind-like bulges curved in a convex manner transversely to their longitudinal axis.

The associated reflector, as shown in FIG. 4A and FIG. 4B, has, at its open end, i.e. at the outer end A of the reflector section 43, an internal diameter, adapted to the lens diameter, of 190 mm (distance a in FIG. 4B) and, at the end B of the section 42, one of 182 mm (distance b). The opening present at the peak C of the reflector has a diameter of 30 mm (distance c). The total length of the reflector, expressed by the length of its longitudinal axis or focal line running through the focal point, is 130 mm (distance d) from the peak C to the point of intersection of the focal line with the plane A at the end of the outer reflector section 43. The distance from the peak C to the centre D of the light source 2 is 31 mm (distance e), the distance from the peak C to the point of intersection of the focal line with the plane B at the end of the middle reflector section 42 is 94.5 mm (distance f) and the distance from the centre D of the light source to the point of intersection of the focal line with the plane A at the end of the outer reflector section 43 is 91 mm (distance g).

The desired light distribution results from an interaction of the two sides of the lens, additionally supported by the reflector, the dimensions of which may likewise vary slightly. The lens optical system according to the invention is intended in particular for the use of high-pressure discharge lamps, in particular of commercially available CDM and CPO lighting means, but can in principle also be combined with other lighting means.

### Lens Variations:

The lens described above produces a rectangular light image having a diffusion angle of about 130°×60° at an angle of inclination of 90° to the planar surface on which the radiation is incident. This corresponds to an effective light field of about 32 m×10 m at a light spot height of 10 m. Lens variations having a slightly modified lens pattern serve for achieving other light diffusion angles, as listed, for example, in table 1 below. For achieving these effects, the angles of the prism-like elevations and the diameter and the inclination of the individual lens elements and optionally the width and extent of curvature of the convex, bead-like bulges are varied.

FIGS. 6 to 9 show a lens variant having a relatively thick edge region 53a which projects beyond the prism edges on the light exit side in order thus, for example, to permit the attachment of a transparent, planar protective cover directly on the lens. In addition, in this variant, the two slanting halves 522a and 523a of the inner lens array on the light exit side—in contrast to the embodiment described above—are not directly adjacent to one another across an imaginary section line 524 but are separated from one another by a planar lens part 524a which appears rectangular in plan view. The structures of this lens variant 5a are likewise readily recognizable from the cross-sectional views of FIGS. 7A, 7B, 9A and 9B. In this embodiment, too, the number of prism rows on the light entry side is 23, that on the light exit side is 38 and the number of convex bulges on the light entry side is 14. Likewise, the two circular halves are arranged so that the rectangular, planar lens section 524a present between them has its longitudinal sides parallel to the prism rows of the annular section on the same lens side, which annular section is adjacent to the circular area. Typically, the lenses according to the invention are integrally formed, independently of their lens geometry, i.e. are not assembled from individual lens parts by adhesive bonding but are cast as a single piece, produced by means of corresponding moulds.

For most intended uses, the general reflector geometry described above can remain unchanged in the case of all lens variations. The reflector length can, however, vary by up to 14 mm with the use of the lens size specified above.

TABLE 1
Side length of the light field in [m] as a function of diffusion
angle and distance from the luminaire to the illuminated area.

| | | Light diffusion angle in degrees | | | | |
|---|---|---|---|---|---|---|
| | | 5° | 15° | 30° | 60° | 90° |
| Distance/ | 1 | 0.09 | 0.26 | 0.54 | 1.15 | 2.00 |
| Height | 2 | 0.17 | 0.53 | 1.07 | 2.31 | 4.00 |
| in metres | 3 | 0.26 | 0.79 | 1.61 | 3.46 | 6.00 |
| | 4 | 0.35 | 1.05 | 2.14 | 4.62 | 8.00 |
| | 5 | 0.44 | 1.32 | 2.68 | 5.77 | 10.00 |
| | 6 | 0.52 | 1.58 | 3.22 | 6.93 | 12.00 |
| | 7 | 0.61 | 1.84 | 3.75 | 8.08 | 14.00 |
| | 8 | 0.70 | 2.11 | 4.29 | 9.24 | 16.00 |
| | 9 | 0.79 | 2.37 | 4.82 | 10.39 | 18.00 |
| | 10 | 0.87 | 2.63 | 5.36 | 11.55 | 20.00 |
| | 11 | 0.96 | 2.90 | 5.89 | 12.70 | 22.00 |
| | 12 | 1.05 | 3.16 | 6.43 | 13.86 | 24.00 |
| | 13 | 1.14 | 3.42 | 6.97 | 15.01 | 26.00 |
| | 14 | 1.22 | 3.69 | 7.50 | 16.17 | 28.00 |
| | 15 | 1.31 | 3.95 | 8.04 | 17.32 | 30.00 |
| | 16 | 1.40 | 4.21 | 8.57 | 18.48 | 32.00 |
| | 17 | 1.48 | 4.48 | 9.11 | 19.63 | 34.00 |
| | 18 | 1.57 | 4.74 | 9.65 | 20.78 | 36.00 |
| | 19 | 1.66 | 5.00 | 10.18 | 21.94 | 38.00 |
| | 20 | 1.75 | 5.27 | 10.72 | 23.09 | 40.00 |
| | 21 | 1.83 | 5.53 | 11.25 | 24.25 | 42.00 |
| | 22 | 1.92 | 5.79 | 11.79 | 25.40 | 44.00 |
| | 23 | 2.01 | 6.06 | 12.33 | 26.56 | 46.00 |
| | 24 | 2.10 | 6.32 | 12.86 | 27.71 | 48.00 |
| | 25 | 2.18 | 6.58 | 13.40 | 28.87 | 50.00 |
| | 26 | 2.27 | 6.85 | 13.93 | 30.02 | 52.00 |
| | 27 | 2.36 | 7.11 | 14.47 | 31.18 | 54.00 |
| | 28 | 2.45 | 7.37 | 15.01 | 32.33 | 56.00 |
| | 29 | 2.53 | 7.64 | 15.54 | 33.49 | 58.00 |
| | 30 | 2.62 | 7.90 | 16.08 | 34.64 | 60.00 |

| | | Light diffusion angle in degrees | | | | |
|---|---|---|---|---|---|---|
| | | 110° | 120° | 130° | 150° | 160° |
| Distance/ | 1 | 2.86 | 3.46 | 4.29 | 7.46 | 11.34 |
| Height | 2 | 5.71 | 6.93 | 8.58 | 14.93 | 22.69 |
| in metres | 3 | 5.87 | 10.39 | 12.87 | 22.39 | 34.03 |
| | 4 | 11.43 | 13.86 | 17.16 | 29.85 | 45.37 |
| | 5 | 14.28 | 17.32 | 21.45 | 37.32 | 56.71 |
| | 6 | 17.14 | 20.78 | 25.73 | 44.78 | 68.06 |
| | 7 | 19.99 | 24.25 | 30.02 | 52.25 | 79.40 |
| | 8 | 22.85 | 27.71 | 34.31 | 59.71 | 90.74 |
| | 9 | 25.71 | 31.18 | 38.60 | 67.18 | 102.08 |
| | 10 | 28.56 | 34.64 | 42.89 | 74.64 | 113.43 |
| | 11 | 31.42 | 38.11 | 47.18 | 82.11 | 124.77 |
| | 12 | 34.28 | 41.57 | 51.47 | 89.57 | 136.11 |
| | 13 | 37.13 | 45.03 | 55.76 | 97.03 | 147.45 |
| | 14 | 39.99 | 48.50 | 60.05 | 104.50 | 158.80 |
| | 15 | 42.84 | 51.96 | 64.34 | 111.96 | 170.14 |
| | 16 | 45.70 | 55.43 | 68.62 | 119.43 | — |
| | 17 | 48.56 | 58.89 | 72.91 | 126.89 | — |
| | 18 | 51.41 | 62.35 | 77.20 | 134.35 | — |
| | 19 | 54.27 | 65.82 | 81.49 | 141.82 | — |
| | 20 | 57.13 | 69.28 | 85.78 | 149.28 | — |
| | 21 | 59.98 | 72.75 | 90.07 | 156.75 | — |
| | 22 | 62.84 | 76.21 | 94.36 | 164.21 | — |
| | 23 | 65.69 | 79.67 | 98.65 | 171.67 | — |
| | 24 | 68.55 | 83.14 | 102.94 | — | — |
| | 25 | 71.41 | 86.60 | 107.23 | — | — |
| | 26 | 74.26 | 90.07 | 111.51 | — | — |
| | 27 | 77.12 | 93.53 | 115.80 | — | — |
| | 28 | 79.98 | 96.99 | 120.09 | — | — |
| | 29 | 82.83 | 100.46 | 124.38 | — | — |
| | 30 | 85.69 | 103.92 | 128.67 | — | — |

In practice, those lens variations which produce light diffusion angles of 30°×60°, 60°×90°, 60°×130°, 60°×150°, 40°×130° or 40°×150° are preferably used. Further variations and combinations of light diffusion angles and the light divergence in metres achievable therewith, as a function of the distance from the luminaire to the area on which the light is incident, are shown in table 1.

Thus, a rectangular light field having a width of about 11.5 m and a length of 20 m, corresponding to an area of about 230 m², is illuminated with the luminaire according to the invention which is described in this example, at a light diffusion angle of 60×90 degrees and with the luminaire mounted at a height of 10 m. With the use of the luminaire according to the invention, high-pressure discharge lamps having a power of 250 W can be replaced by those having a power of only 70 W or optionally even 35 W with equally good visibility of the object on which the light is incident.

LIST OF REFERENCE NUMERALS

| | |
|---|---|
| 1 | Luminaire according to the invention |
| 2 | Lighting means |
| 3 | Lamp housing |
| 4 | Reflector |
| 41 | Parabolic reflector section |
| 42 | First conical reflector section |
| 43 | Second conical reflector section |
| 5, 5a | Lens |
| 51, 51a | Light entry side of the lens |
| 52, 52a | Light exit side of the lens |
| 53, 53a | Annular, unstructured edge zone of the lens |
| 511 | Annular lens section on light entry side, |
| | having a venetian blind-like surface |
| | structure comprising convex, bead-like bulges |
| 512 | Central, circular section on the light entry |
| | side, having a surface structure comprising |
| | parallel rows of elongated, tapering prisms |
| | having an approximately triangular cross- |
| | section |
| 521 | Annular section on the light exit side, |
| | having a lens structure comprising parallel |
| | rows of elongated, tapering prisms having a |
| | triangular cross-section |
| 522, 523 | Wedge-shaped semicircular area of the |
| 522a, | central, circular section on the light exit |
| 523a | side |
| 524, 524a | Imaginary section line or strip-like lens |
| | section between the wedge-shaped semicircular |
| | areas, on the light exit side |

1. Headlight lens (5, 5a) in the form of a circular disc, suitable for producing a rectangular light field on a planar surface, having a light entry side (51, 51a) which is to face a lighting means, having an associated surface structure, and a light exit side (52, 52a) located opposite the light entry side and having an associated surface structure, characterized in that the lens (5, 5a) has the following features:
a) on the light entry side, a central, circular section (512) having a surface structure comprising a multiplicity of elongated, prisms arranged parallel to one another and spanning the respective total available circular area and having an approximately triangular cross-section and, located in between, approximately U-shaped trough-like valleys;
b) on the light entry side, immediately adjacent to the circular section (512) and completely surrounding said section, an annular section (511) having a surface structure comprising a multiplicity of elongated venetian blind-like bulges which are arranged parallel to one another and are convex transversely to their longitudinal axis and which span the respective total available annular area;
c) on the light exit side, a central, circular section having two semicircular halves (522, 523, 522a, 523a) which are of equal size, have a wedge-shaped radial cross-section and, along an imaginary section line (524), are either directly adjacent to one another or are separated from one another by a strip-like lens section (524a), have their thinnest point in the region of the imaginary section line and become thicker from there in a centrifugal direction, so that their planar surfaces represent skew planes which rise in the direction towards the edge of the lens;
d) on the light exit side, immediately adjacent to the circular section and completely surrounding said section, an annular section (521) having a surface structure comprising a multiplicity of elongated prisms arranged parallel to one another, spanning the respective total available annular area and having a triangular cross-section and, located in between, V-shaped valleys; and
e) on the light entry side and light exit side, immediately adjacent to the annular sections and completely surrounding said sections, a peripheral, annular edge zone (53, 53a) without surface structure;
on the light entry side, the elongated, venetian blind-like bulges of the annular section (511) being arranged rotated through an angle of 90° relative to the elongated prisms of the circular section (512) on the same side thereof, moreover, on the light exit side, the imaginary section line (524) and the strip-like lens section (524a) between the semicircular sectional halves running in the same direction as the elongated prisms of the annular section on this side, and the elongated prisms on the light entry side and those on the light exit side being arranged so as to run in the same direction.

2. Lens according to claim 1, characterized in that the peripheral, annular edge zone (53, 53a) has a thickness which is sufficient for projecting beyond all surface structures arranged inside the edge zone.

3. Lens according to claim 1 or 2, characterized in that it has 23 elongated prisms and 40 elongated, convex bulges on the light entry side and 38 elongated prisms on the light exit side.

4. Lens according to any of claims 1 to 3, characterized in that the elongated prisms comprise those or consist of those whose free edge pointing away from the lens surface is rounded.

5. Lens according to any of claims 1 to 4, characterized in that it consists of toughened glass or an impact-resistant and scratch-resistant, transparent, colourless plastic, in particular of polycarbonate.

6. Luminaire (1) equipped with a lens (5, 5a) according to any of claims 1 to 5.

7. Luminaire according to claim 6, comprising a lighting means (2), a housing (3), a reflector (4) and the lens (5, 5a), characterized in that the reflector (4) is formed rotationally symmetrically about its longitudinal axis and, in the axial direction, is composed of three sections (41, 42, 43) of different geometry, that section (41) of the reflector (4) which is closest to the lighting means having the form of a paraboloid of rotation and having an opening at the peak, and the two adjacent sections (42, 43) each possessing the form of a truncated cone widening conically towards the lens, the outer section (43) having a greater slope than the preceding, middle section (42) and optionally also possibly being in cylinder form.

8. Luminaire according to claim 6 or 7, characterized in that the opening at the peak of the first reflector section (41) is dimensioned for the passage of a lighting means, in particular of a discharge lamp, a lamp holder or cables for power supply.

9. Luminaire according to any of claims 6 to 8, characterized in that the reflector (4) is made of light metal, in particular of aluminium, and has a highly polished or reflective inner surface in the first two sections (41, 42) and a roughened inner surface in the third, conical or cylindrical section (43).

10. Luminaire according to any of claims 5 to 9, characterized in that the lens (5, 5a) is detachably fastened to the lamp housing (3) and is preferably rotatably mounted in the lamp housing (3).

11. Use of a lens according to any of claims 1 to 5 for producing a rectangular light field.

12. Use of a luminaire according to any of claims 6 to 10 for illuminating large areas, such as public squares, recreation parks, sports fields, football stadia, ski slopes, sport and industrial halls, car parks, multi-storey car parks, traffic areas of all kinds, tunnels, building facades, airports, seaports, military areas, advertising boards or exterior facades of buildings.

13. Use of a luminaire according to any of claims 6 to 10 as a component of optical presentation systems, such as projectors and beamers, as a photographic light or as a special luminaire in medical facilities, in particular as an operating theatre luminaire or dental luminaire, or in museums for illuminating pictures or other exhibits.
